(19) United States
(12) Patent Application Publication
(10) Pub. No.: US 2021/0118026 A1
(43) Pub. Date: Apr. 22, 2021

(54) SYSTEMS AND METHODS FOR FACILITATING DISASTER RELIEF

(71) Applicant: Miracle Relief Collaboration League, Austin, TX (US)

(72) Inventor: Kathryn Ingerly, Piedmont, OK (US)

(21) Appl. No.: 17/074,476

(22) Filed: Oct. 19, 2020

Related U.S. Application Data
(60) Provisional application No. 62/916,909, filed on Oct. 18, 2019.

(51) Int. Cl. G06Q 30/06; G06Q 30/02; G06Q 30/08; G06Q 50/26; G06Q 30/00; G06F 16/27

(52) U.S. Cl. CPC G06Q 30/0607; G06Q 30/0279; G06F 16/27; G06Q 50/26; G06Q 30/018; G06Q 30/08

(57) ABSTRACT

A method for facilitating disaster relief includes receiving a donation offer at a disaster relief server system. The disaster relief server system stores a plurality of aid requests from a plurality of requesters. Each requester of the plurality of requesters has an associated requester type. The donation offer identifies a good or service. The method further includes receiving a requester restriction associated with the donation offer at the disaster relief server system, the requester restriction providing a constraint on requester type; matching a requester to the donation offer based at least in part on the good or service and based at least in part on the constraint; facilitating a transaction provisioning the good or service to the matched requester; and recording the transaction in a distributed ledger system.

### CROSS-REFERENCE TO RELATED APPLICATION(S)

This application claims benefit of U.S. Provisional Application No. 62/916,909, filed Oct. 18, 2019, which is incorporated herein by reference in its entirety.

### BACKGROUND

Weather events and natural disasters, such as hurricanes, typhoons, blizzards, tornadoes, volcanoes, and earthquakes, generally result in large-scale property damage, loss of power, and disruption of supply chains. Similarly, epidemics and pandemics cause wide-spread disruption in service and supply chains. As such, many people are displaced from their homes, lose access to food or water, or generally suffer financial hardship as a result of a natural disaster or pandemic. Moreover, the very businesses and government agencies upon which individuals rely on a daily basis are disrupted because both their employees and their supply chain are affected by local conditions. As such, those that are affected by the natural disaster are left without resources familiar to them.

On the other hand, natural disasters and pandemics spark an outpouring of support and interest in offering donations. Government agencies, charitable organizations, for-profit companies, and the general public show an interest in providing resources, money, and services to those in need as a result of the natural disaster. Nevertheless, there is difficulty in connecting a particular resource with an individual or organization in need of that particular resource. As a result, resources are inefficiently distributed, whereby needed supplies are in excess in some locations, while lacking in other locations.

Moreover, in the context of the chaos within these post natural disaster situations or pandemics, certain individuals take advantage, hoarding resources they do not need or absconding with monies donated for charitable causes.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an example communications network to facilitate disaster relief.

FIG. 2 includes an illustration of an example disaster relief network.

FIG. 3 includes an illustration of an example system for provisioning disaster relief.

FIG. 4 includes an illustration of an example database associated with a disaster relief system.

FIG. 5 and FIG. 6 include illustrations of example transactions to be stored within a disaster relief system.

FIG. 7, FIG. 8, FIG. 9, FIG. 10, and FIG. 11 include block flow diagrams illustrating example methods for facilitating disaster relief.

FIG. 12, FIG. 13, FIG. 14, FIG. 15, FIG. 16, and FIG. 17 include illustrations of an example mobile application for facilitating disaster relief.

FIG. 18, FIG. 19, FIG. 20, FIG. 21, FIG. 22, FIG. 23, FIG. 24, FIG. 25, FIG. 26, FIG. 27, FIG. 28, and FIG. 29 include illustrations of an example user interface for facilitating disaster relief.

FIG. 30 includes a block flow diagram illustrating an example method for provisioning medical and pharmaceutical assistance.

FIG. 31 includes a block flow diagram illustrating an example method for facilitating medical or pharmaceutical transactions in a disaster relief system.

FIG. 32, FIG. 33, FIG. 34, FIG. 35, FIG. 36, and FIG. 37 include example screenshots of a disaster relief system.

The use of the same reference symbols in different drawings indicates similar or identical items.

### DETAILED DESCRIPTION

In an embodiment, a disaster relief system includes computational resources dedicated to receiving donation offers, requests for aid, and offers of volunteer services. The system facilitates connecting requests for aid with resources associated with the donation offers and facilitates transportation of physical goods between donors, distribution centers, organizations, and individuals. Transactions associated with the provisioning of goods or services through the system are recorded in a distributed ledger system. Optionally, the system can track offers of volunteer services and request for associated services. In a particular example, the system permits donors or recipients to maintain anonymity. In a further example, the system allows donors to restrict how donations are used or by whom. The system can further allow recipients to restrict from whom donations are received.

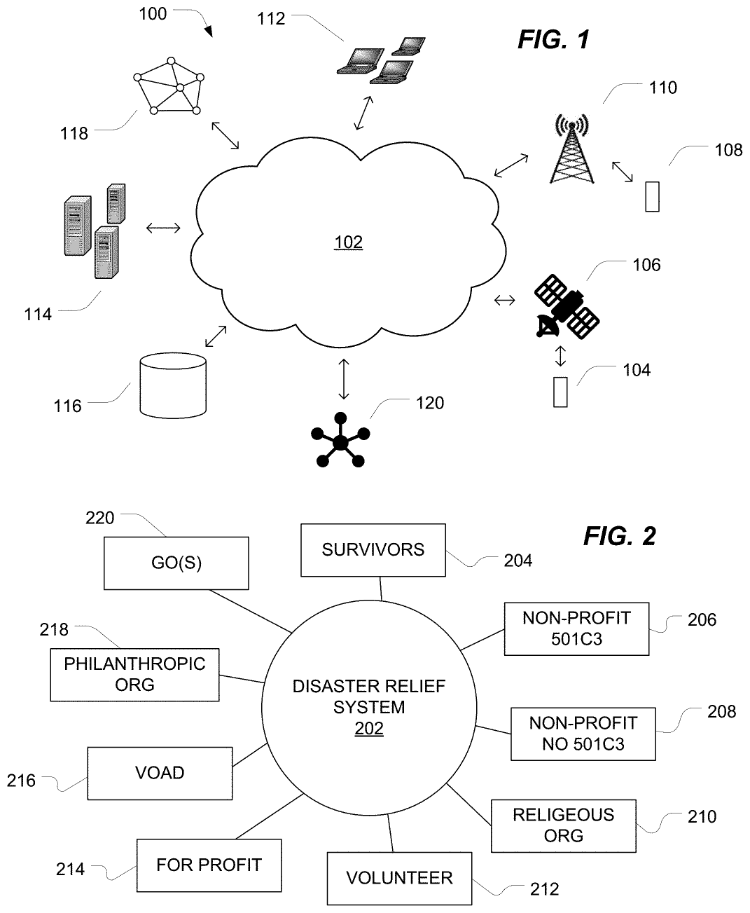

FIG. 1 includes an illustration of an example communications network useful in facilitating disaster relief. A wide area or global network 102, such as the Internet, can be accessed using a variety of communications means to interact with networked resources useful in facilitating disaster relief, and in particular, for connecting offered resources with those in need. For example, a satellite phone 104 can access the network 102 via satellite communication 106. In another example, a mobile phone or tablet 108 can access the network 102 through a cellular network 110. In a further example, computers 112, such as desktop computers, laptop computers, or other computational devices can access the network 102 through wired or wireless sources. In particular, survivors in need and organizations distributing relief can access the network to request assistance. Further, donors can access the network 102 to offer donations. In another example, volunteers can access the network 102 to offer services and update availability.

Such users of the network 102 can access network assets that facilitate disaster relief. For example, users can access a set of servers 114 connected to the network 102 to interact with the databases 116 or distributed ledger systems 118 also connected to the network 102. Facilitators accessing the network can utilize the servers 114, the database 116, and the distributed ledger system 118 to connect donations with recipients and facilitate the provisioning of goods and services. In addition, other resources 120, such as mapping resources, weather resources, government databases, or banking systems, among other remote resources can be utilized by the system to assist with facilitating disaster relief.

In particular, a variety of organizations can interact through a virtual system established to facilitate disaster relief. Third parties can validate and verify members accessing the network, connect donors or donated resources with those in need of the resources, and record the transactions in an immutable ledger to provide an auditable tracking of resources through the system, and optionally anonymity to both donors and recipients. For example, FIG. 2 includes an illustration of an example disaster relief system 202 that can be accessed by various persons and organizations, including those providing goods and services, as well as those in need of such goods and services. For example, survivors 204, nonprofit 501(c)(3) organizations 206, nonprofit organizations 208 that do not have 501(c)(3) status, religious organizations 210, volunteers 212, for-profit organizations 214, associations of volunteer organizations active in disaster (VOAD) 216, other philanthropic organizations 218, and government organizations 220 can access a single disaster relief system 202 to facilitate the provisioning of goods and services from one set of organizations to other organizations and persons in need.

For example, survivors 204 can access the network 202. In an example, survivors 204 can indicate a need, their location, and particular details relating to their situation. Parties associated with the disaster relief system 202 can direct the survivors 204 to services and resources that meet their needs. For example, the disaster relief system 202 can direct survivors 204 to nonprofit organizations 206 or 208, religious organizations 210, or other services and resources.

Similarly, nonprofit organizations, such as a nonprofit having 501(c)(3) status 206 or a nonprofits having no 501(c)(3) status 208, or a religious organizations 210 can request resources through the system 202. Such nonprofit organizations 206 or 208 and religious organizations 210 may administer to more than one survivor or groups of survivors and can request through the system 202 resources and support for those survivors 204.

Alternatively, the nonprofit organizations 206 or 208 or religious organizations 210 can be donors, donating resources through the network 202. Similarly, for-profit organizations 214, VOAD organizations 216, other philanthropic organizations 218, or government organizations 220 can offer resources through the system 202. For example, for-profit organizations 214 can offer monetary support, food supplier, toiletries, tools, or volunteer hours from their pool of employees. Medical or pharmaceutical resources can be for-profit organizations, government organizations, or charitable organizations. In particular, medical resources can include physician offices, hospitals, trauma clinics, temporary aid stations, or other permanent or temporary facilities. Pharmaceutical resources can include existing pharmacies or drug stores or temporary facilities. In another example, groups of volunteer organizations such VOADs 216 or other philanthropic organizations 218 can offer resources and volunteer hours into the system 202.

Furthermore, government organization 220 can offer resources into the system 202. Oftentimes, such government organizations 220 may pre-position resources in regions proximal to a natural disaster in order to quickly supply such resources into regions affected by the natural disaster. Such government organizations 220 can efficiently distribute resources through the system 202.

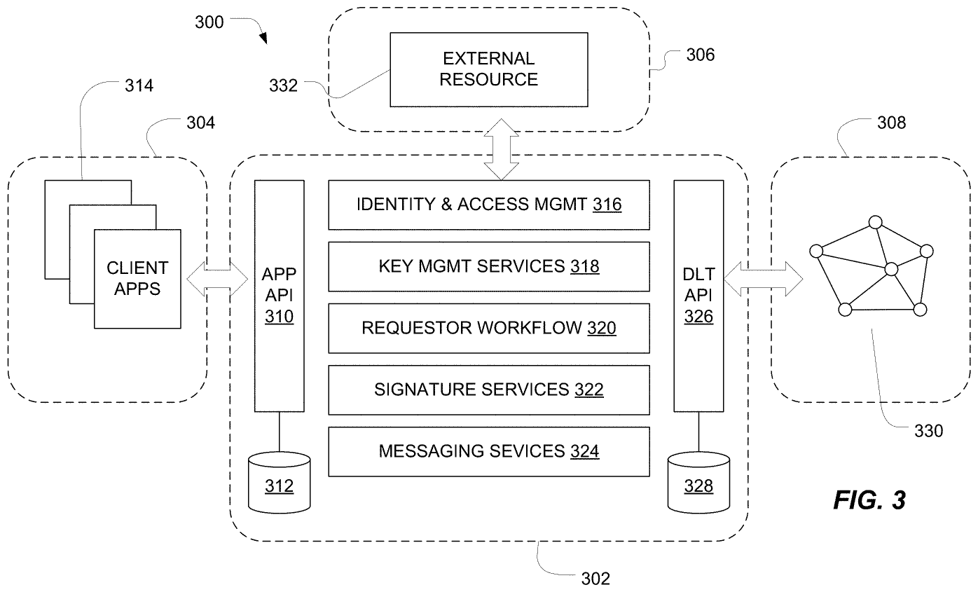

FIG. 3 illustrates an embodiment of a network implementation 300. A service environment 302 is accessed from a client environment 304 to request and provision resources. Transactions associated with the provisioning of such resources can be stored in a distributed ledger environment 308. Further, the service environment 302 can access an external environment 306 to acquire additional information useful for provisioning resources.

In an example, the service environment 302 can include an identity and access management module 316. Such a module 316 can be used to manage access to the system, such as through passwords and logins. In another example, the identity and access management module 316 can identify users using scan codes, such as barcodes or QR codes. Further the identity and access management module 316 can maintain additional data associated with the identity of those accessing the system. The service environment 302 can further include a key management services module 318 to manage the system, computational resources associated with the system and system security.

The service environment 302 can further include a requester workflow module 320. Such a workflow module 320 can be used to manage requests, donation offers, offers of volunteer services, and other resources, such as medical or pharmaceutical resources. In particular, users of the requester workflow module 320 can connect resources with needs and facilitate transactions. For example, a user can identify offered goods, find an organization requesting such goods, and facilitate transportation of the goods offered to the organization. In another example, availability of medical or pharmaceutical resources, such as medical treatment, medicines, testing (e.g., COVID-19 testing), or vaccines can be identified and communicated through the system. For example, medial or pharmaceutical facilities information, such as wait time and availability, can flow into the workflow module 320 to facilitate queue management.

The signature services module 322 can manage encrypted and decryption of information stored in databases or the distributed ledger environment 308. Further, the signature services module 322 can manage security with the service environment 302.

Further, the service environment 302 can include messaging services 324. Such messaging services can interact with API 310 to interact with client applications 314. In particular, the messaging services 324 can interact with client apps 314 to allow the system 300 to identify donations, requests for aid, collect information or details regarding the requests or offers, and interact with other resource environments 306, such as external resources 332.

Example client applications 314 can be implemented using IOS, Android, or other mobile device operating systems. In another example, client applications 314 can be implemented in laptop, tablet, desktop, or server environments.

While individual modules are identified and described, additional modules can be included that enhance the performance of the service environment 302. Further, functionality ascribed to a module can be alternatively implemented in other modules.

In particular, aspects of the modules 316, 318, 320, 322, and 324 interact with client applications 314 through application interface 310. The applications API 310 can be or have an associated database 312 to assist with provisioning interface through the client applications 314.

The service environment 302 can access an external resource environment 306 that includes external resources 332. Example external resources 332 include maps, weather reports, government database, news outlets, available medical or pharmaceutical resources, and other information that can be gathered and utilized as either part of the requester workflow or to be provided to the client applications 314 through the API 310. In an example, open medical facilities, occupancy or utilization rates (e.g., wait times), availability of testing (e.g., available COVID-19 testing kits), or availability of vaccines (e.g., status of stock and source of vaccine) can be provided through the external resources environment 306.

Further, as transactions within the network are facilitated, such as the provisioning of donations from a donor to a recipient, such transactions can be recorded in a distributed ledger environment 308 including a peer-to-peer network 330 implementing a distributed ledger technology via distributed ledger technology API 326. Optionally, the API 326 can include a database 328 supporting the functionality of the API 326. The distributed ledger environment 308 can implement peer-to-peer networks 330 running voting or consensus algorithms. Such a peer-to-peer network 330 can be a private network or public network. In particular, the network resources (e.g., nodes) associated with the network 330 can be distributed geographically distant from the natural disaster. In a particular example, the network implements a distributed ledger technology, such as Blockchain or Hashgraph. As such, transactions stored within the distributed ledger environment 308 are immutable and can provide an audit trail for resources entering and being distributed through the system.

In an example, the network 330 can implement Blockchain, which includes a consensus mechanism to ensure only valid transactions are stored within the system. The network 330 further provides provenance and an audit trail for flow of resources between participants. Trusted partners are able to verify/validate ecosystem participants. Further, trusted, permissioned data can be shared transparently across multiple parties with different levels of privilege without a central authority.

In addition, such a system can encourage “gray relief” by showing unofficial relief data to only permissioned non-government partners, which enhances the flow of aid from non-government approved sources. Security within the system protects sensitive but vital medical info and provides secure channels for sensitive data.

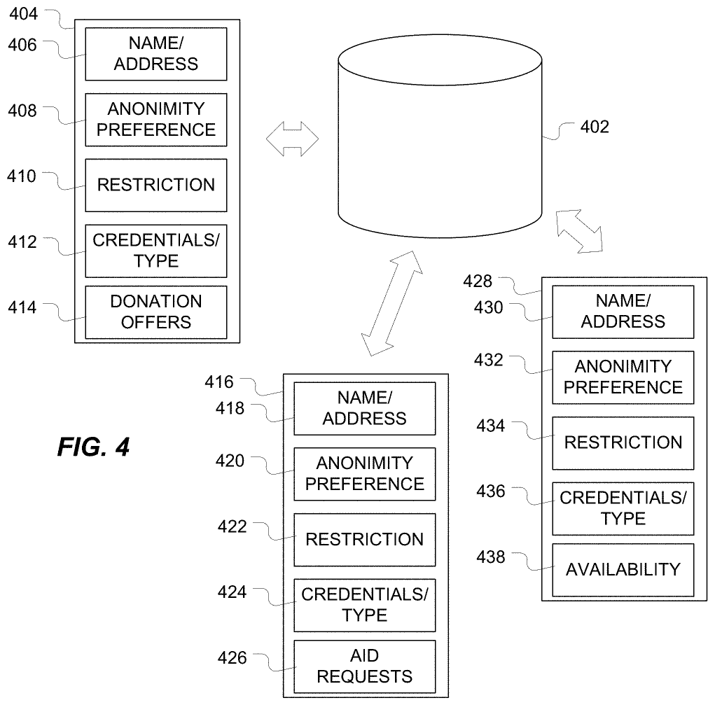

As illustrated in FIG. 4, modules of the service environment 302 can implement or access a database, such as a database 402. In an example, the database 402 can include a donor record 404. The donor record 404 can include identifiers of the donor, such as names and addresses 406. Further, the record can store an anonymity preference 408. For example, the donor may wish to remain anonymous or unknown to other members of the disaster relief system.

Further, the donor record 404 can include restrictions 410. In an example, the donor can limit or restrict to whom donations provided by the donor are provisioned. In some cases, donors may have a religious or ethical objection to donating to particular organizations. In other examples, donors may wish their goods donations to support a particular cause or need among those requesting assistance.

Optionally, the donor record 404 can include a credential or type 412. For example, the donor 404 may be identified as a volunteer organization, a nonprofit organization, a religious organization, or a government organization, a medical or pharmaceutical organization, among other types. In addition, the donor record 404 may include a record of donor offers 414. For example, the donor record 404 may include items donated or offered for detonation by the donor.

Similarly, the database 402 can include a requester record 416. For example, the requester record 416 may include identifying information, such as names and addresses 418 of the requester. The requester record 416 may also include an anonymity preference 420. For example, the requester may prefer to remain anonymous once verified by parties managing the disaster relief system. In such an example, the requester 416 may not be identified to government organizations or donors.

Further, the requester record 416 can include a list of restrictions 422. In particular, certain requesters may desire to receive goods and services from private donors, avoiding government entanglements.

In another example, the requester record 416 can include a credentials record 424. For example, the requester may be a nonprofit religious organization. Example nonprofits may be 501(c)(3) certified or may not have 501(c)(3) status. In addition, the requester record 416 can include a history of aid requests 426. For example, the requester record 416 can include items requested by requester.

In a further example, the database 402 can store a volunteer record 428. Volunteer record 428 can include names and addresses or other identifiers 430 associated with the volunteer. The volunteer may also prefer to remain anonymous. As such, the volunteer record 428 can include an anonymity preference 432. In addition, the volunteer may have preferences as to whom such services are offered and for whom the volunteer desires not to perform services. As such, volunteer record 428 can include restrictions 434. In addition, the volunteer record 428 can include credentials or type 4346, such as transportation, demolition, general repairs, landscape cleanup, or other services. The volunteer record 428 also include availability or a history of service 438.

While the records are illustrated as a single document, the information represented by the record can be stored in various formats within a relational or object database.

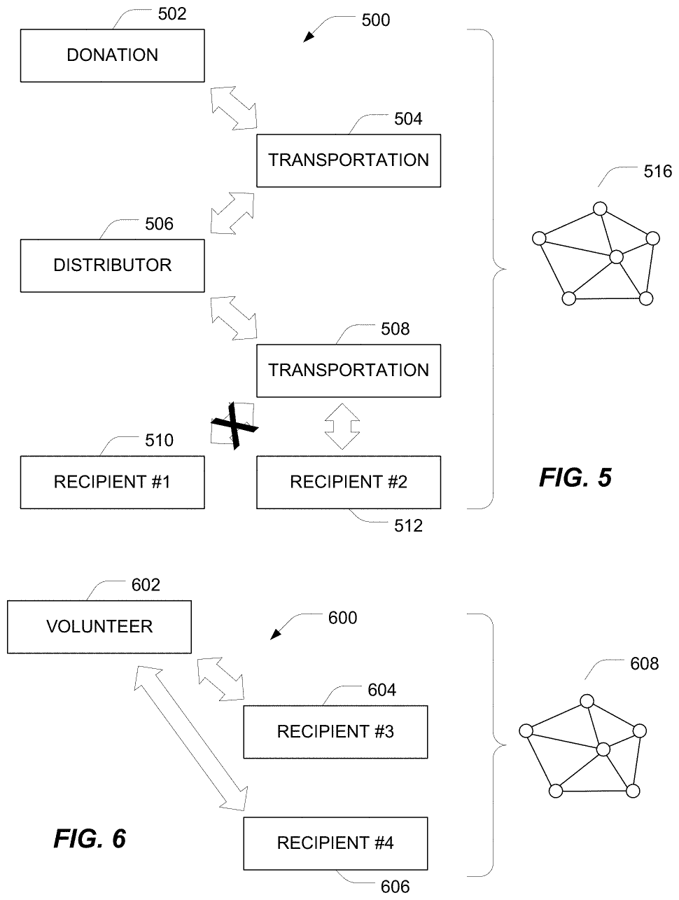

FIG. 5 represents an example scheme 500 for the distribution of donations. For example, a donor may offer a donation 502. The donor may provide restrictions as to who may receive the donation. Furthermore, one or more recipients 510 or 512 may have requested resources similar to or equivalent to the donation 502. As such, the disaster relief system can identify transportation services to facilitate transport of the donation 502 to one or more of the identified recipients 512. In the event that a donor or recipient desires to remain anonymous, further steps may be implemented within the donation schema 500 to further facilitate anonymity among donors or recipients. In the illustrated example, the donation 502 is transported by transportation 504 to a distribution center 506. Based on the restrictions of the donor, the recipient #1 510 may not be eligible to receive the donation, the recipient #2 512 may meet the donor's criteria. As such additional transportation 508 can be arranged to deliver the donation to the recipient #2 512. Each of the transactions, such as picking up the donation by transportation 504 or dropped off the donation at the distributor 506, can be recorded within a distributed ledger system 516. As such, the transactions involving donations are immutably stored in a tamper resistant environment, which can be audited.

In another example illustrated in FIG. 6, a schema 600 includes a volunteer 602 offering time and services. The system can determine one or more recipients 604 or 606 and direct the volunteer 602 to provide such services to the recipients 604 or 606. Efforts by volunteer 602 can be treated as a transaction and can be stored in a distributed ledger system 608.

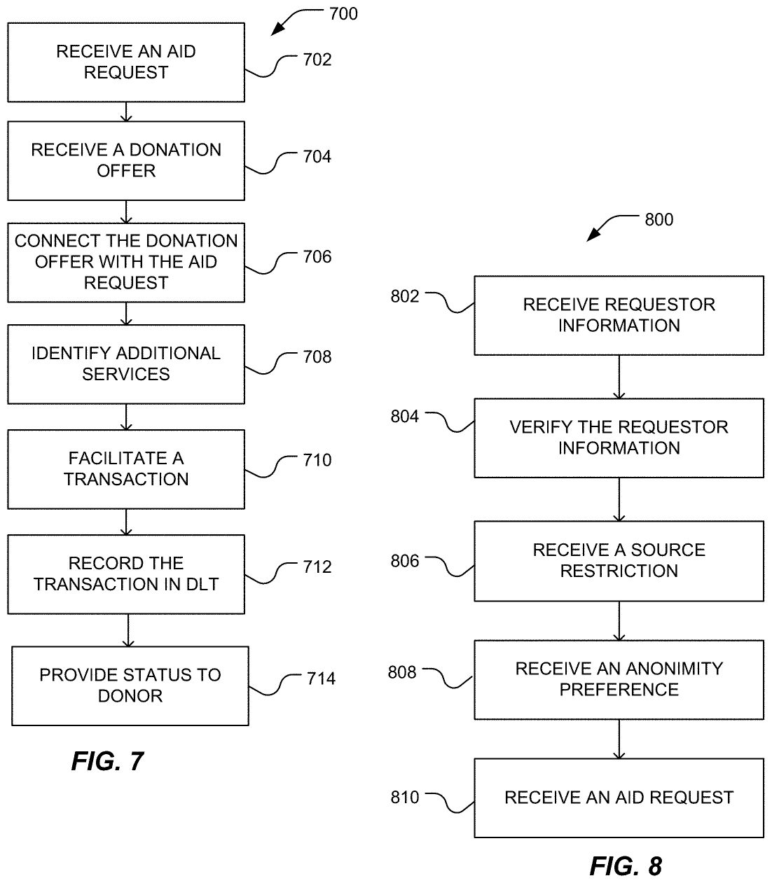

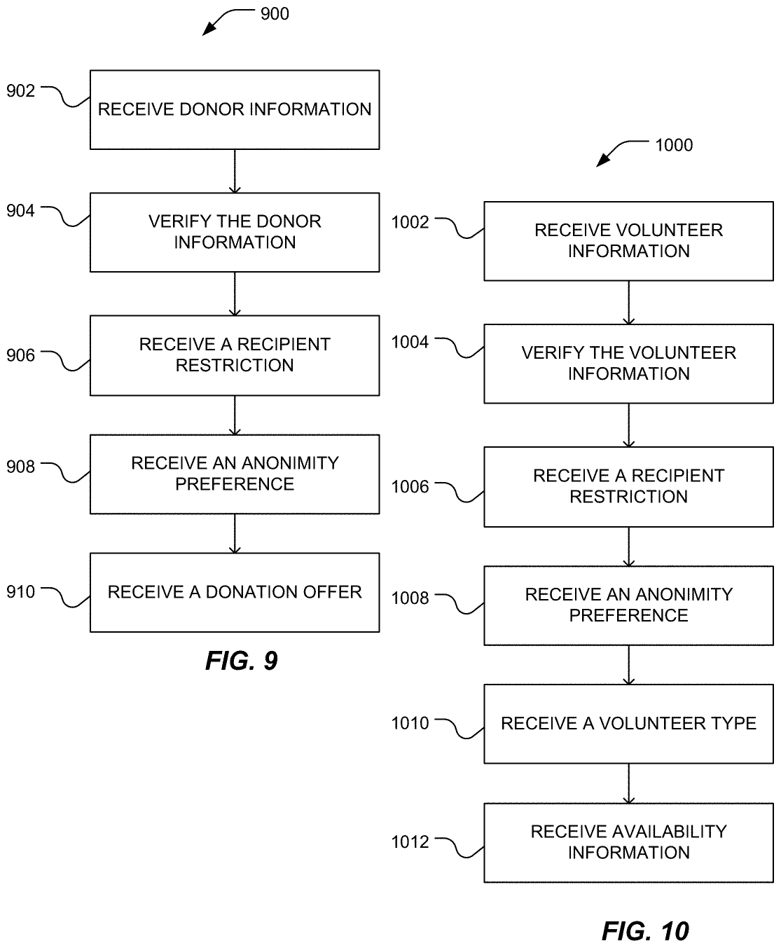

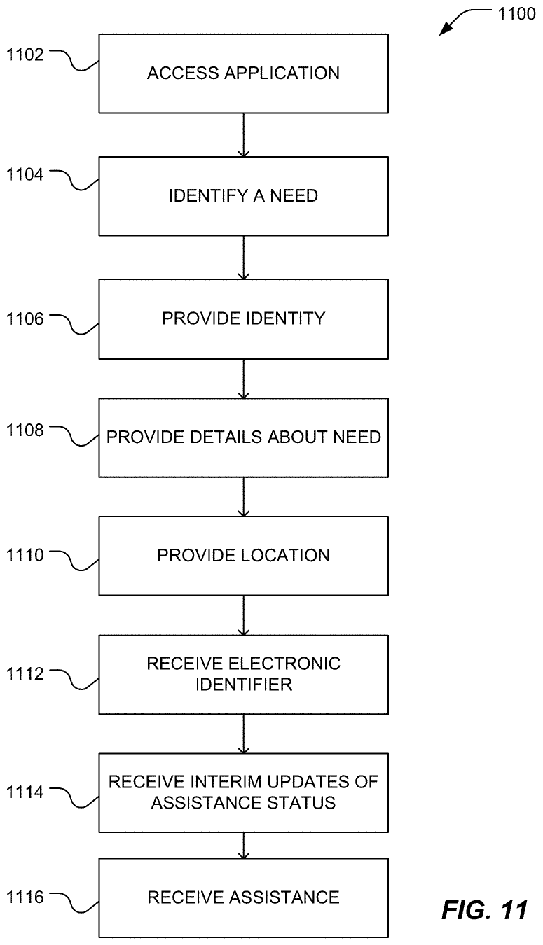

FIG. 7 includes a block flow diagram of an example method 700 for requesting aid through the disaster relief network. For example, a survivor or organization can request aid, as illustrated at block 702. Such requests can be facilitated through client applications, phone calls, faxes, or other means.

In addition, the disaster relief system can receive a donation offer, as illustrated at block 704. For example, individuals, nonprofit organizations, for-profit organizations, medical or pharmaceutical organizations, or government entities can offer resources to be distributed through the disaster relief system. Alternatively, for-profit medical or pharmaceutical organizations can provide information regarding the availability of services, testing, pharmaceuticals, and vaccines.

Managers of the disaster relief system can connect the donation offer with a request, as illustrated at block 706. Alternatively, connections can be made automatically by resource environment modules within the system. For example, resources such as food offered by a donor can be compared to aid requests made by survivors or an organization in support of displaced people. Connecting the donation offer with aid request can further be constrained by restrictions applied by either the donor or the requester.

As illustrated at block 708, additional services can be identified. For example, the provisioning of goods through the system may utilize transportation services. In another example, volunteer services such as demolition, landscape clearing, or other volunteer services may be associated with the aid request.

Once the donation offer is connected to a request, a transaction can be facilitated that results in the distribution of the donation to requesters, as illustrated at block 710. Transportation can be arranged for goods to be distributed from donors to requesters or from distribution centers to requesters. In another example, medical or pharmaceutical services can be facilitated, for example by arranging an appointment or allocating an available resource, such as a testing kit or vaccine. Such transactions can be recorded in a distributed ledger system, as illustrated at block 712. As such, the transactions can be recorded in a tamper-resistant immutable environment that allows auditing and tracking of resources distributed through the disaster relief system.

Optionally, as illustrated at block 714, the system can provide a status of the donation to the donor. In particular, when the recipient request anonymity, the donor can be notified of the status and compliance with any restrictions place on the donation without providing the identity of the recipient.

FIG. 8 illustrates an example method 800 for receiving an aid request. The requester can be an organization that distributes aid, for example to individuals or survivors, or the requester can be a survivor. A survivor, is generally, an individual or group of individuals, such as a family. For example, the system can receive requester information, as illustrated at block 802. For example, the requester can provide such information through a client app, a website, or by calling a volunteer. Parties within the disaster relief network can verify the requester information, as illustrated at block 804. For example, volunteers may verify the existence and validity of organizations requesting aid. In another example, the system may request government issued identification, such as a driver's license, a passport, or other means of identifying a survivor.

The requester may further provide a source restriction, as illustrated block 806. For example, the requester may desire not to receive aid from government organizations or a VOAD. In another example, the requester may have religious or ethical restrictions associated with receiving goods from particular donors.

The requester may further provide an anonymity preference, as illustrated at block 808. For example, once verified, the requester may desire to be remain anonymous to others providing resources into the system.

The system can then receive an aid request, as illustrated at block 810, identifying the needs of the survivor or organization. For example, the aid request could include a request for food, water, toiletries, other supplies, or services. In another example, the aid request can include medical treatment or pharmaceutical needs. In a particular example, the request can include a request for testing (e.g., for COVID-19) or for vaccines.

FIG. 9 illustrates a method 900 for receiving donation offers. For example, the system can receive donor information, as illustrated at block 902. Such donor information can include identifiers such as name and address, credentials, or other information. The parties within the system or the system itself can verify the donor information, as illustrated at block 904. For example, organizations desiring to donate may be verified as existing nonprofit or for-profit companies. Alternatively, ad hoc organizations responding to the perceived need for disaster relief may be verified through individual leaders associated with the organization.

The system can receive a recipient restriction, as illustrated at block 906. For example, some donors may have an ethical or religious objection to providing goods or services to particular organizations. In another example, a donor may desire to address a particular need among the many needs arising out of or in the context of a natural disaster or pandemic.

The donor may also desire to remain anonymous to others accessing the system. As such, the donor may provide and the system can receive an anonymity preference, as illustrated at block 908.

Further, the system can receive a donation offer, as illustrated at block 910, identifying the goods being offered by the donor. For example, the donor may offer to provide food, water, toiletries, or other supplies. In another example, the donor can offer monetary support.

While the methods above reference donations and donors, the methods can apply to the provisioning of medical services and pharmaceutical supplies whether provided by government or charitable organizations or for profit by a for-profit entity. In particular, the system can receive information regarding the availability of medical or pharmaceutical services or supplies and direct requester to the available services or supplies.

FIG. 10 illustrates a method 1000 for receiving an offer of volunteer services. For example, the system can receive volunteer information, such as name and location, as illustrated at block 1002. The volunteer information can further include government issued identification, such as a driver's license or a passport or other information about volunteer. Parties associated with the system or the system itself can verify the volunteer information, as illustrated at block 1004. In particular, the identity of volunteer can be confirmed.

The volunteer can provide, and the system can receive a recipient restriction, as illustrated at block 1006. For example, the volunteer may have an ethical, religious, or moral objection to delivering services to particular organizations. In another example, the volunteer may desire to meet particular needs within the region affected by the natural disaster. As such, volunteer can provide the recipient restrictions.

Further, the volunteer may desire to be remain anonymous to others accessing the disaster relief network. As illustrated at block 1008, the system can receive an anonymity preference from the volunteer.

As illustrated at block 1010, the volunteer can provide a volunteer type. For example, the volunteer may be a transport volunteer. In another example, the volunteer may be a demolitions volunteer. In a further example, the voluntary can offer landscape clearing or volunteer to work in food kitchens or other distribution centers. In addition, the system can receive from the volunteer information regarding availability, such as time of day and locations, as illustrated at block 1012.

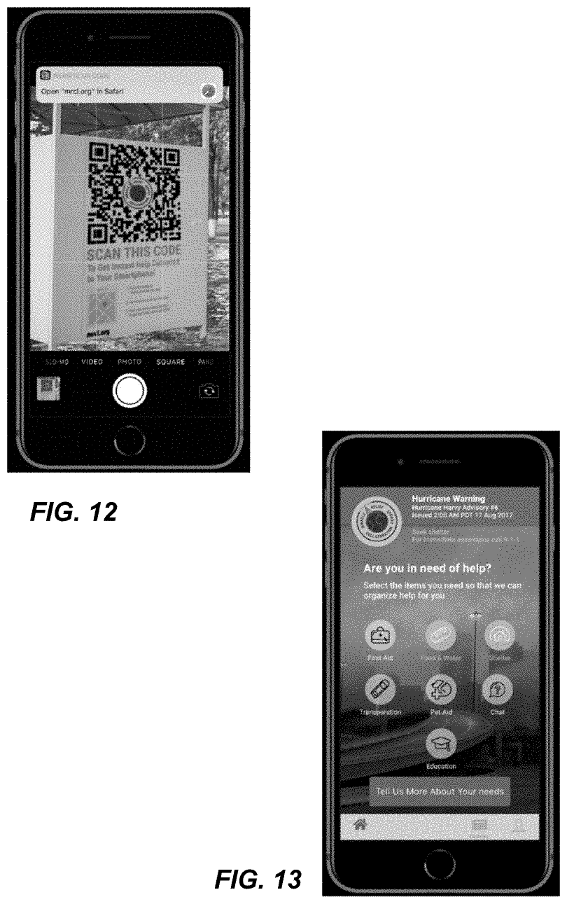

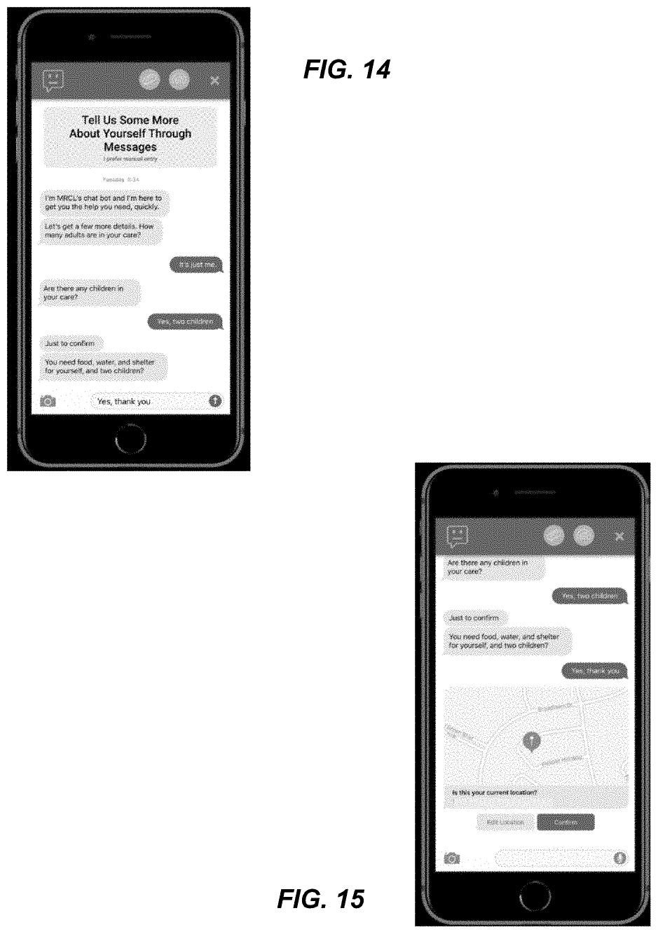

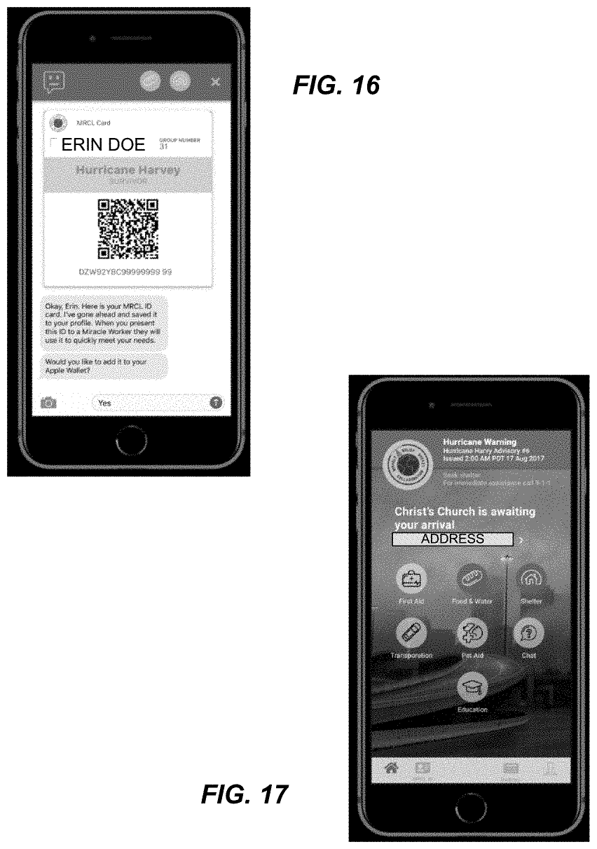

In a further example, survivors may access the distributed disaster relief system. For example, as illustrated in FIG. 11, a method 1100 can be used by survivors to access the system. In an example, the volunteer can access an application, as illustrated at block 1102. For example, the application can be a smart phone or tablet application. In an example illustrated in FIG. 12, signs may be provided with codes, such as QR codes, readable by cell phones or other portable devices that direct survivors to download an application to access resources within the disaster relief system. An example of such an application is illustrated in FIG. 13.

As illustrated at block 1104, the survivor can identify a need such as food or water and shelter, first aid, transportation, pet aid, or education. In another example, a user can request access to testing, such as for COVID-19, or access to a vaccine. For example, the survivor can press icons within an application, for example, illustrated in FIG. 13, to indicate needs. In addition, the survivor can use the application to provide an identity, as illustrated at block 1106.

As illustrated at block 1108, the survivor may be prompted to provide additional details about the need. Such details may be provided over the phone. Alternatively, as illustrated in FIG. 14, FIG. 15, and FIG. 16, a user may interact with a messaging system that asks specific questions associated with the survivors need. The system can further identify the survivor's location, as illustrated block 1110 (FIG. 15), and provide an electronic identifier, such as a QR code illustrated in FIG. 16, to the survivor, as illustrated at block 1112. As such, the survivor's identity and need can be readily accessed by organizations associated with the disaster relief network.

Optionally, they system can provide updates regarding the status of the request, as illustrated at block 1114. For example, when the request includes a request for supplies, the status and optionally, approximate delivery time/date can be provided.

Further, the survivor can be directed to locations where the survivor can receive assistance or be provided with the requested supplies, as illustrated at block 1116. For example, the application can provide an address of an organization proximal to the location of the survivor, as illustrated in FIG. 17, through the mobile application. In another example, the requested supplies can be delivered.

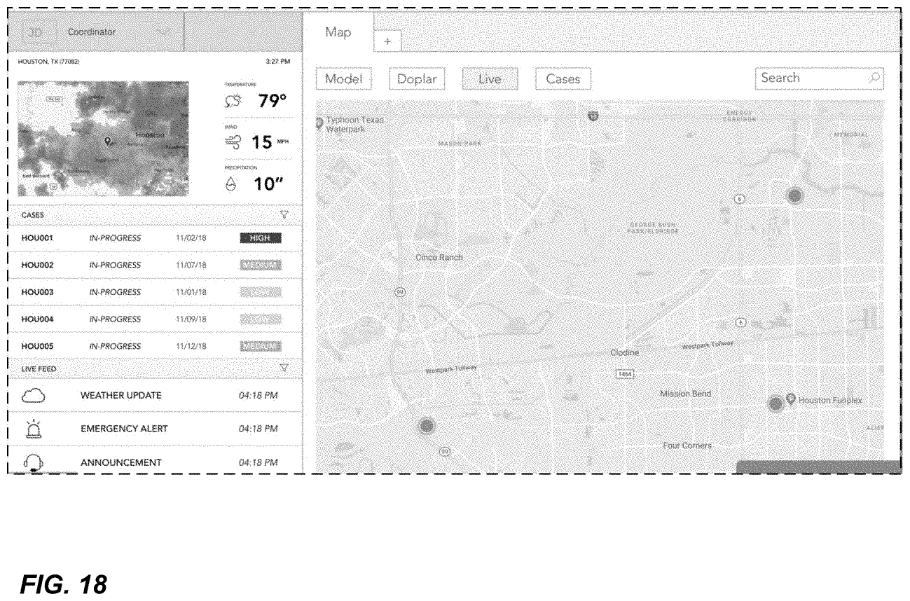

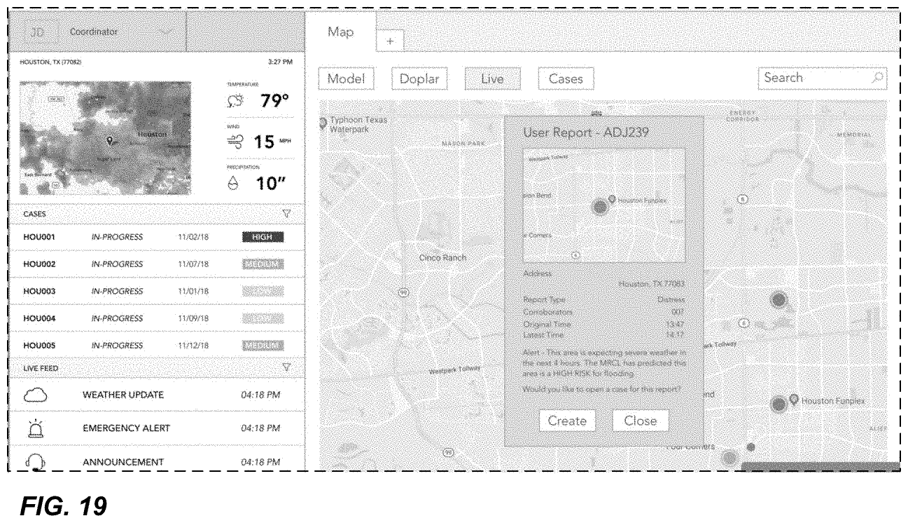

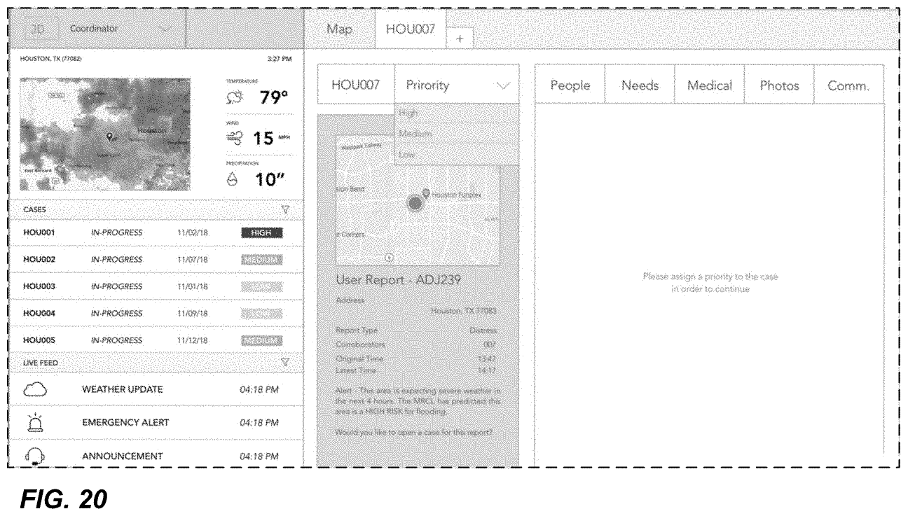

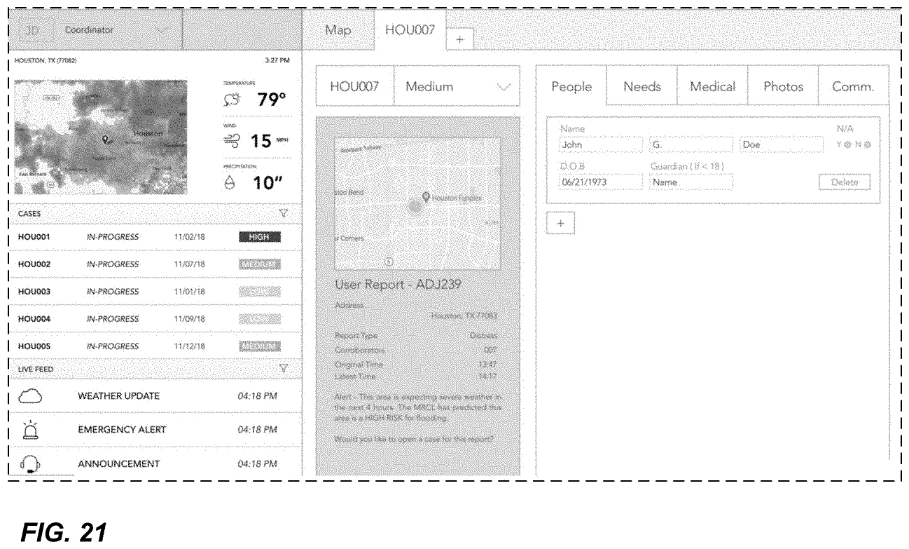

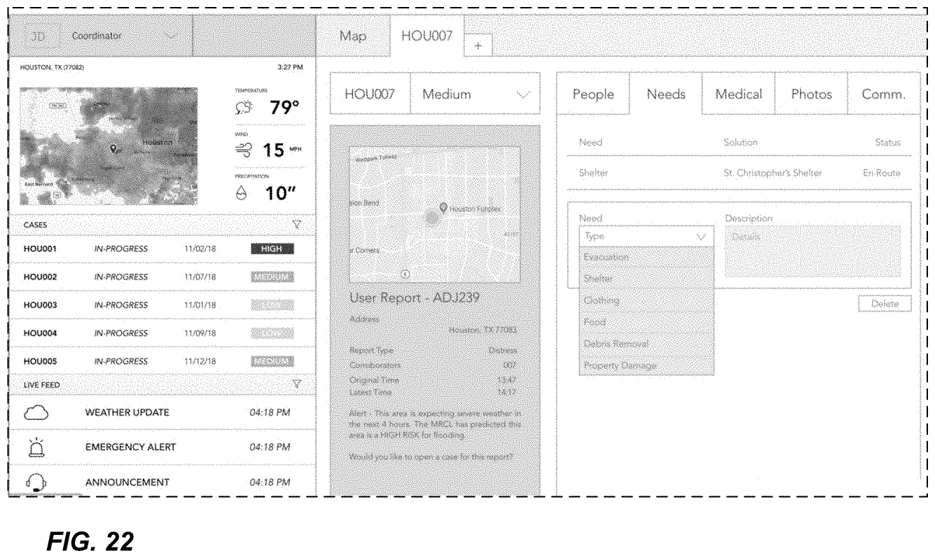

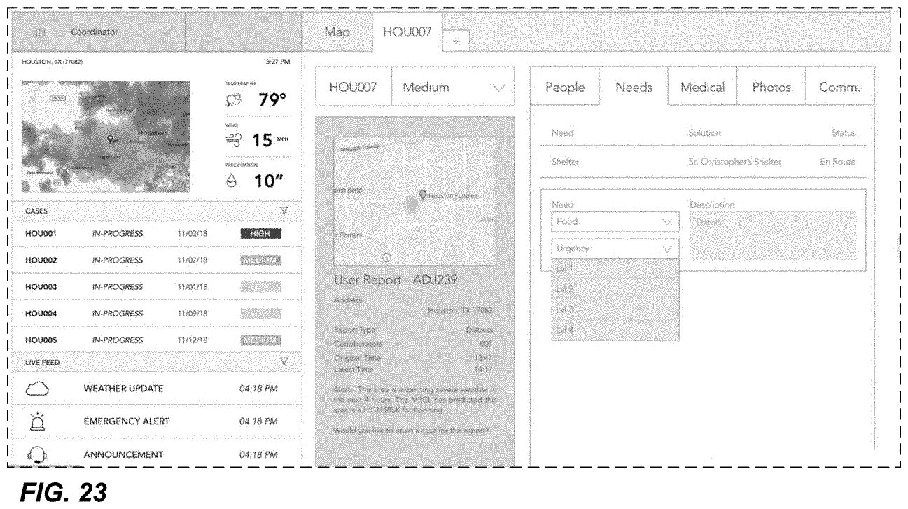

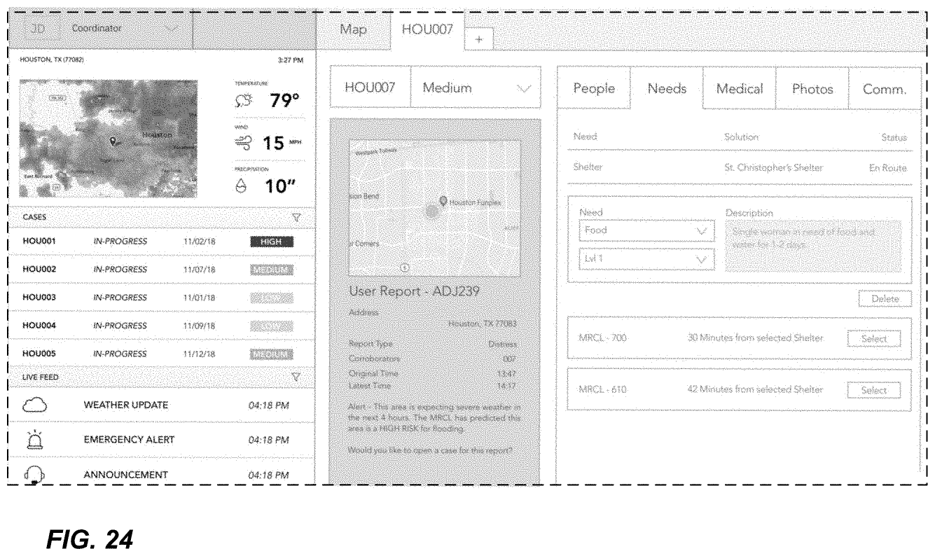

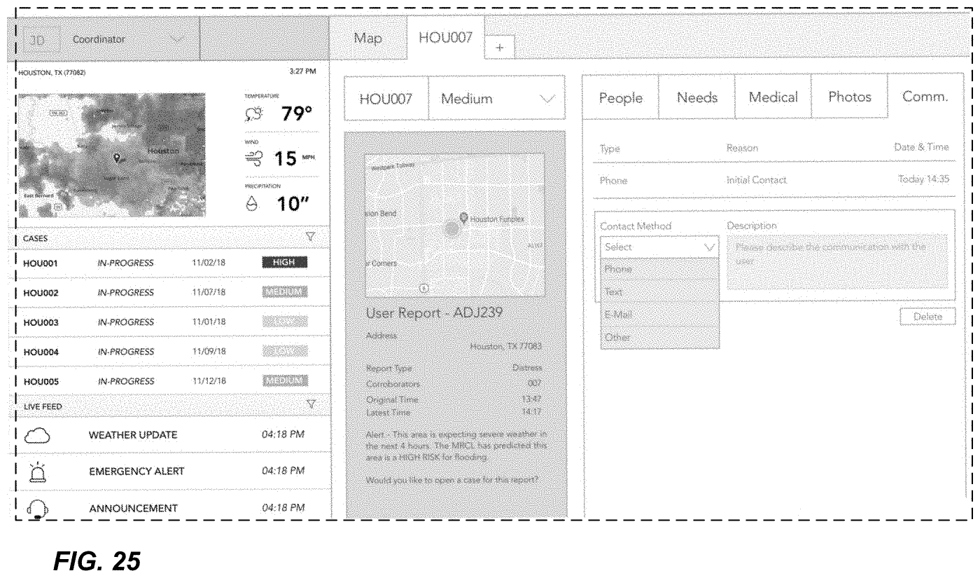

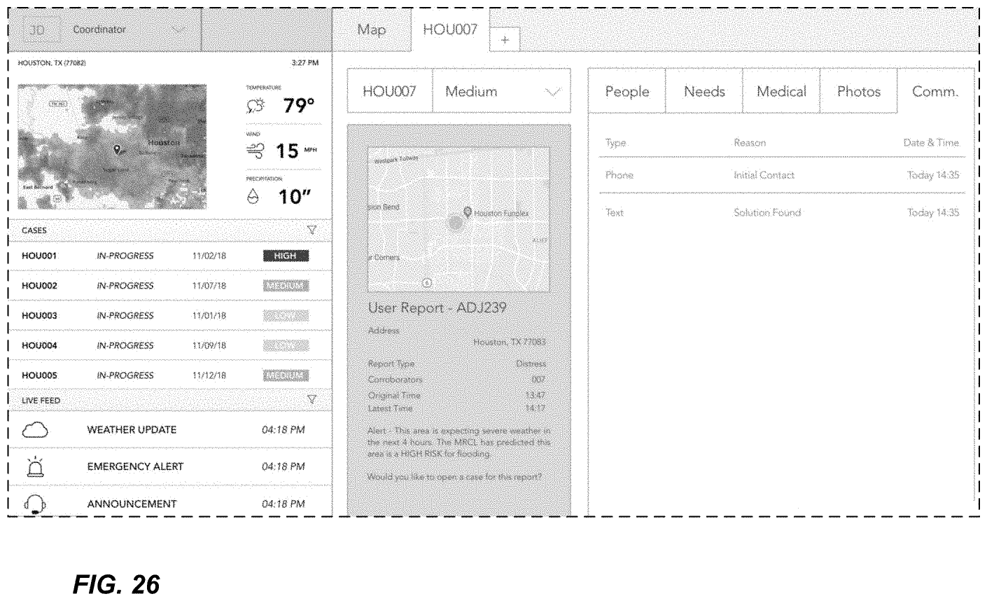

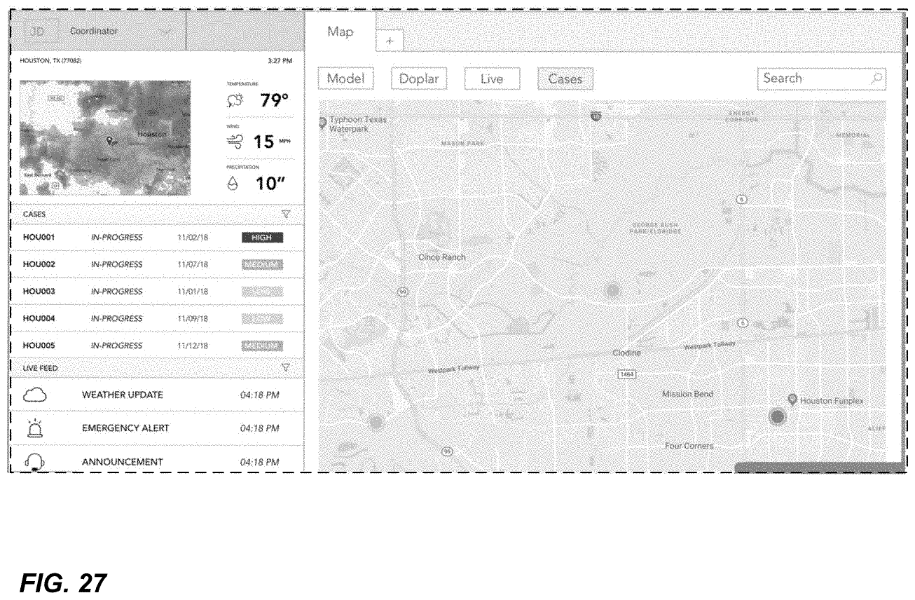

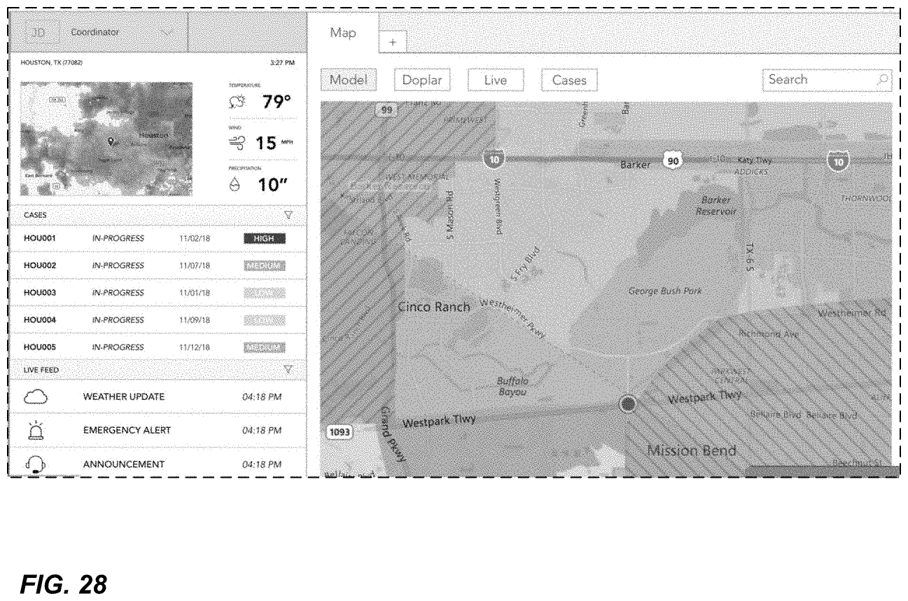

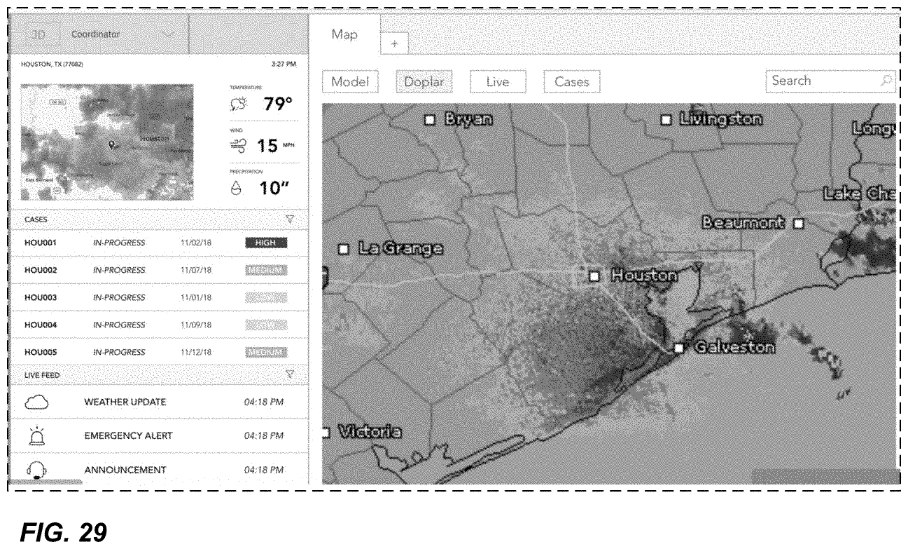

Facilitators within the network can be provided with a user interface to assist with identifying needs and connecting such needs with resources. For example, such interfaces can be provided using the networked system of FIG. 3. In an example, FIG. 18 illustrates an example interface that includes weather information, a list of cases in progress, and informational feed, as well as an interface to identify a survivor in need. The interface can be used to record communications, identify people, identify needs, identify medical resources and photos. In the example illustrated in FIG. 18, various contacts with potential survivors in need are identified by location on a map. The facilitator can select a contact to open an information window that provides the option to create a new record, as illustrated in FIG. 19.

When creating a new record, the facilitator can select a level of priority, as illustrated at FIG. 20. Further, the facilitator can enter a name and other information about the survivor, as illustrated at FIG. 21. For example, the facilitator can collect a name and date of birth for each member of a party. In an example, the facilitator can further enter information about the preferred contact method for the survivor and can enter additional information about the survivor. Optionally, the facilitator can collect addresses, names of relatives, or other identifying information. When the party is a minor, the facilitator can record the name of their guardian. Alternatively, the system may populate the information based on entries in the associate mobile application.

Needs identified by the survivor can be entered into the system. For example, the type of need can be entered, as illustrated in FIG. 22, and the level of need can be entered, as illustrated at FIG. 23. Alternatively, the needs can be populated based on entries from the mobile application. The system can suggest locations at which such a need can be meet, as illustrated at FIG. 24. Optionally, the facilitator can select one of the suggested organization that may be able to meet the needs of the survivor. The information can be provide to the survivor by phone, text, or through the mobile application.

In addition, each contact with the survivor or other related party can be tracked. As illustrated at FIG. 25, each contact can be recorded, for example, specifying the method contact, the reason for the contact, and the date and time of the contact. Once the record is complete, the system can change the status of the survivor record, as illustrated at FIG. 26, and further indicate such status on the map, as illustrated at FIG. 27.

The user interface can further provide information from external resources, such as map overlays of area designations or weather conditions. For example, FIG. 28 illustrates a map overlay. Such an overlay may be derived from a government source indicating the effected areas, flood plains, jurisdictions, areas assigned to a particular organization, or other geographic information. In another example illustrated in FIG. 29, weather conditions can be presented. Further, other weather-related information can be overlaid on the map, such as rainfall totals, lightning strikes, wind speeds, among others.

In particular, the users, including administrators, donors, other providers, requestors, and survivors, interact through a system that records the exchanges in a core ledger, which is secured and immutable. Multiple donors or entities can make offers into the system and multiple recipients or survivors can benefit through the provisioning of the offered aid while remaining anonymous and abiding by constraints and preferences. While each entity or individual may have limited access to the information in the system, the transactions are stored in the core ledger system and can be audited as needed, providing a verifiable and trusted system. The system is scalable beyond initial implementation areas/organizations for broader use.

In an example, the system can be used for provisioning medical or pharmaceutical resources, such as, for example, testing and vaccination, such as during a pandemic. The system includes an internet accessible application, providing a searchable table of testing or vaccine facilities, the testing or vaccine facility status (open or closed) and the ability to schedule into the nearest location. Each patient is assigned a unique case number and selects an appointment time as they proceed to identify a testing or vaccine facility and identify their symptoms and exposure criteria. The system provides a core ledger using a distributed ledger approach, such as Blockchain, securing the case number, zip code location, and symptoms of the inquiring party or patient, and automatic matching to the closest available testing or vaccine facilities. The security of the distributed ledger system reduces the fear of forced actions and causes more people to search and register for testing or vaccination, creating more accurate geo-picture of the unfolding epidemic.

A health system recipient of this information receives pre-notice through the application of the volume of people expected within certain timeframes, as well as some indication of the severity of presenting symptoms and exposure of those coming for testing, and the eventual medical equipment, supplies, and personnel needed for a response.

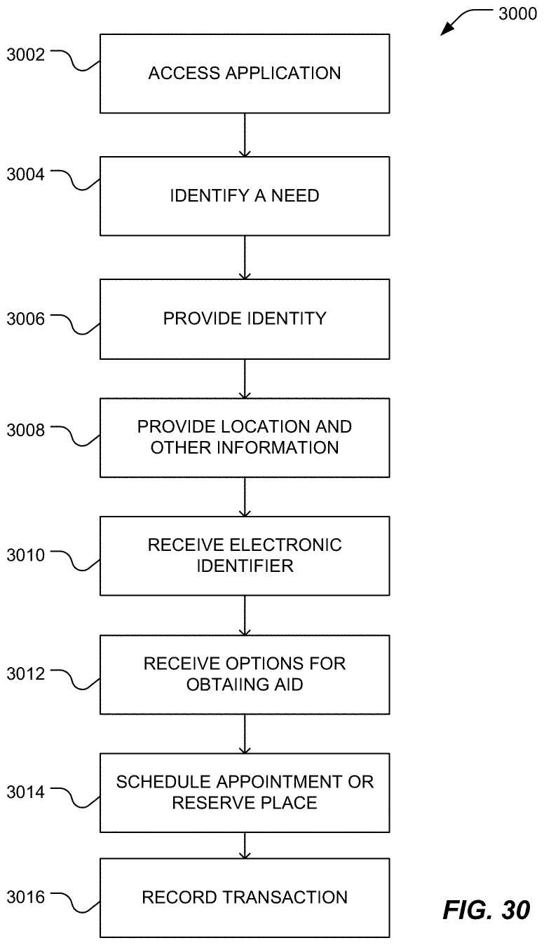

In a particular example, the system can be used to facilitate provisioning of medical or pharmaceutical services, such as testing or vaccination during a pandemic. Individuals can access a mobile application that interacts with the disaster relief system to facilitate provisioning of testing or vaccination needs. For example, FIG. 30 illustrates a method 3000 to guide an individual to a testing or vaccination facility. Such facilities can include emergency rooms, physician's offices, urgent care centers, pharmacies, mobile medical units, among other facilities.

The method 3000 includes accessing the application, as illustrated at block 3002. For example, a user can access the mobile application through a portable device, such as a tablet or smartphone. In an example, the application can be the application described in relation to FIGS. 12-17.

As illustrated at block 3004, the user can identify a need. For example, a button provided by the mobile application can relate to a need for testing or a need for a vaccine. As described above, a button associated with testing or vaccination can be one of several buttons relating to other needs that can be provisioned for by the system. For example, the user may request testing for COVID-19.

As illustrated at block 3006, the application can request identifying information from the user. The user can provide such information through the mobile application. In addition, the user can provide a location and other information, as illustrated at block 3008. In particular, the user can provide through the mobile application a zip code or street address. In addition, the user can provide exposure status or symptoms (e.g., fever, cough, sore/dry throat, or difficulty of breathing). Optionally, the user will be provided the option to maintain anonymity or restrict from which donor the user is willing to accept the requested medical or pharmaceutical treatments.

The system can provide an electronic identifier, such as a numerical or alphanumerical identifier, to the mobile application. The mobile application receives the electronic identifier, as illustrated 3010. In an example, the mobile application can provide the electronic identifier, such as a barcode or QR code. Such electronic identifier can be used by the user to identify themselves at a medical or pharmaceutical facility. As such, anonymity can be maintained through to the point where medical services or treatment are rendered.

Based on the requested medical treatment or pharmaceutical services, the system can determine a list of potential providers including, identifying which ones have the available supplies and whether or not they are busy, as illustrated at block 3012. For example, the system may identify several physician offices, urgent care centers, or mobile testing units that have available tests for a virus, such as COVID-19, or a vaccine. Such options can be provided to the mobile application, optionally including a number of available tests or whether the facility is busy, so that the user can select a desired testing facility. Along with the options, the user may also be provided with directions, drive time, and operational hours.

The user may be given the option to go now for testing or treatment or to make a reservation. Based on urgency, the user may proceed to an available testing facility that appears less busy. Alternatively, the user may be provided with the option to schedule an appointment or reserve a place, as illustrated at block 3014. The user may be provided with a confirmation number.

Scheduled appointments or reservations can then be provided to the treatment provider or treatment facility. As such, the treatment facility can prepare for an appointment, be aware of a volume of potential patients arriving, and schedule appropriate staffing, for a given situation.

As illustrated at block 3016, the transaction can be recorded in the distributed ledger system. As such, an immutable record that maintains anonymity of the parties can be stored. In a further example, when arriving for the appointment at the testing facility for which a reservation has been made, the user can provide the facility with their electronic identifier or confirmation number provided through the mobile application. As such, the testing facility can connect the reservation with the patient and optionally update the status of the request. In some cases, the patient can maintain anonymity throughout the process. In other situations in which, for example, medical insurance is used, the patient may provide their identity directly to the medical facility.

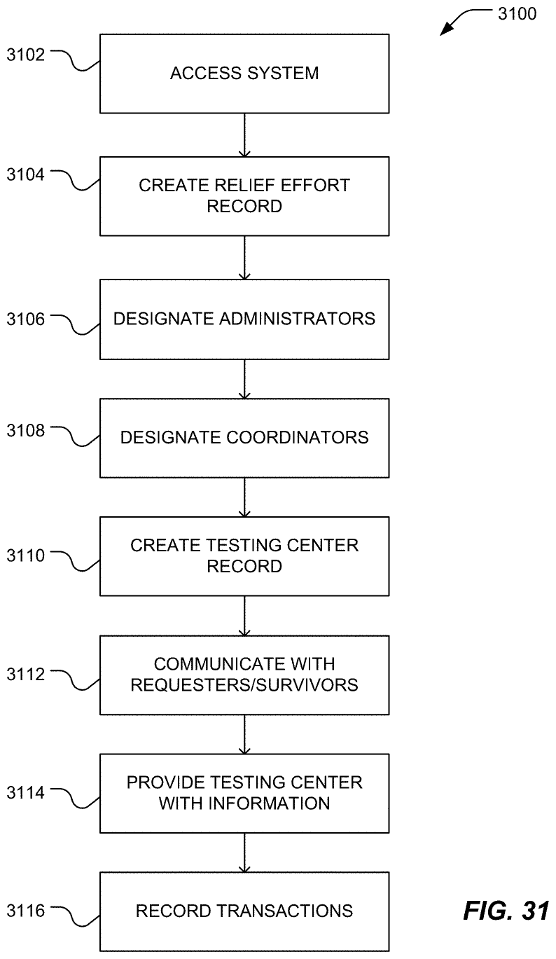

FIG. 31 illustrates a method 3104 using a distributed ledger system to provision medical or pharmaceutical services, such as testing for viruses or vaccinations. The method 3100 includes accessing the disaster relief server system, as illustrated at 3102. For example, an administrator can access the disaster relief server system through a computer or laptop across the Internet or through a mobile application.

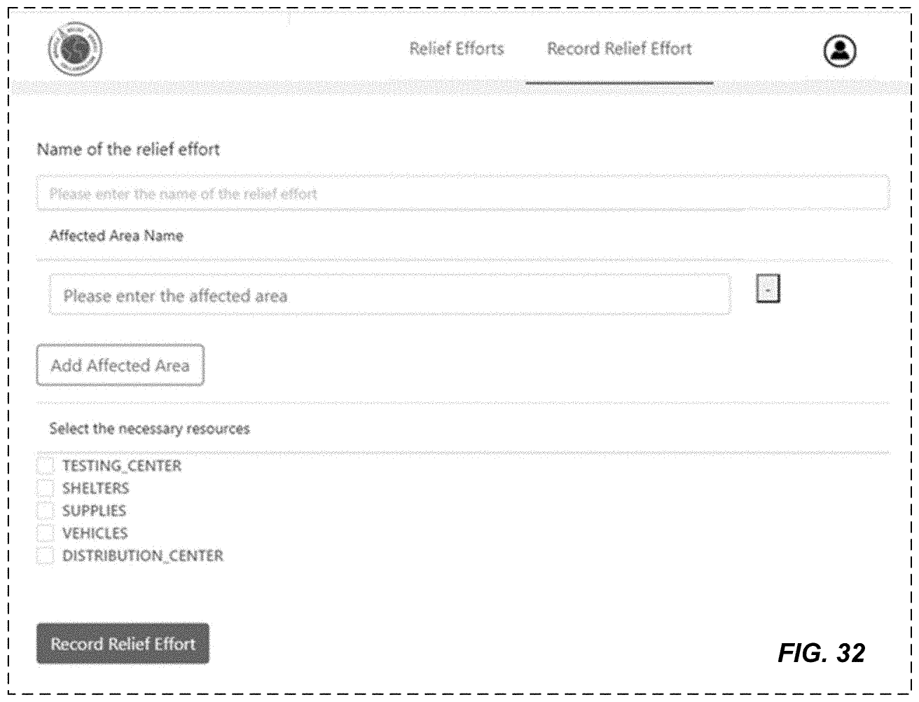

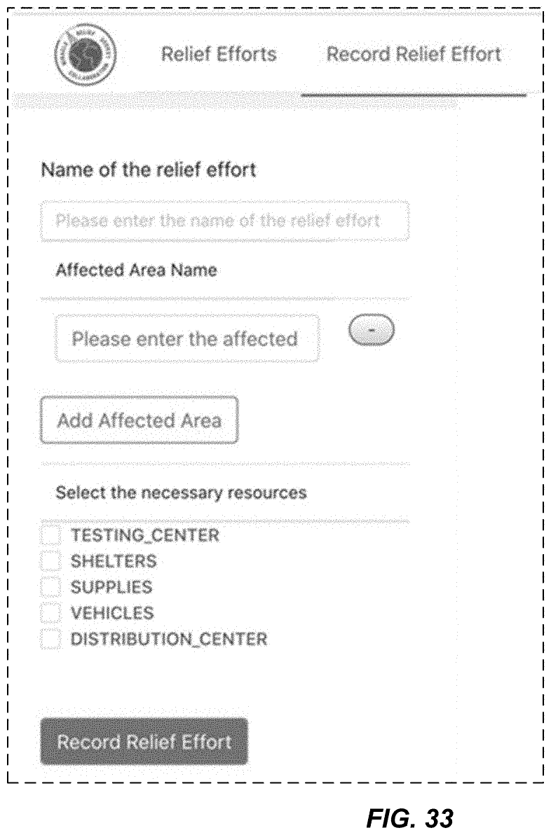

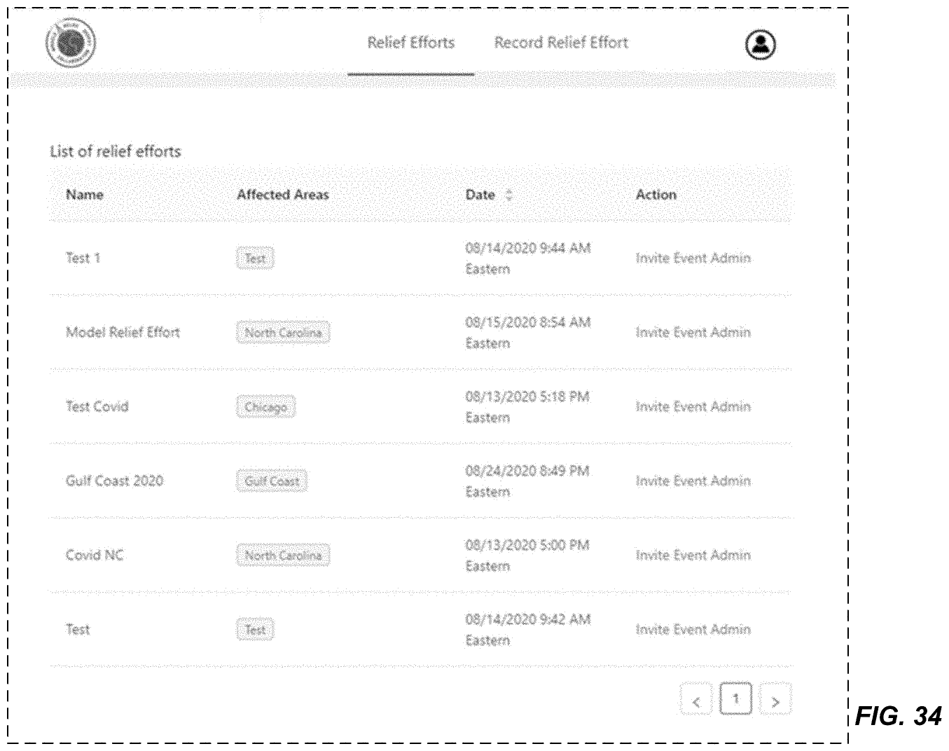

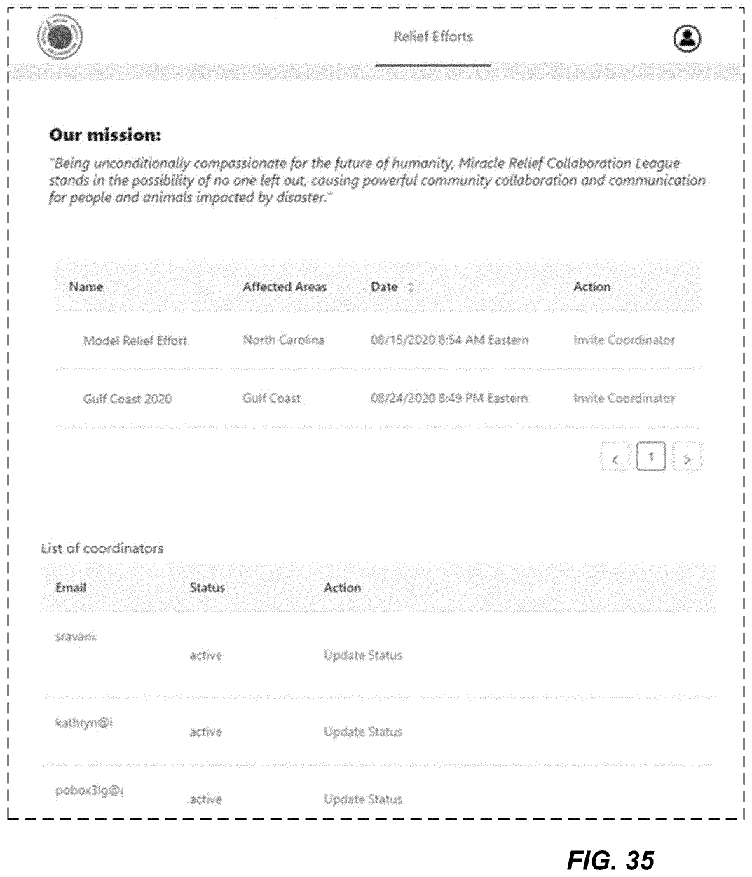

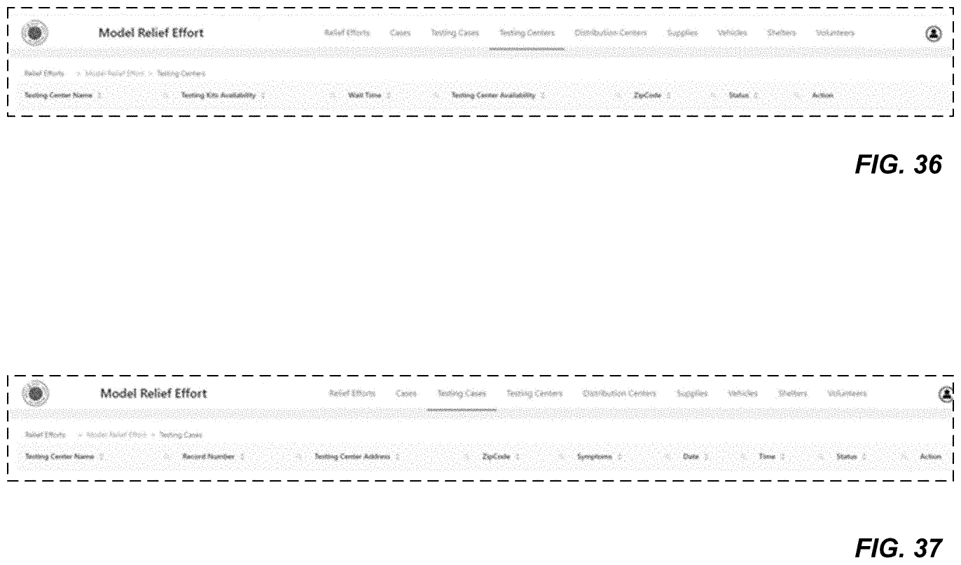

As illustrated at block 3104, the administrator can create a relief effort record. Such a record may include a name for the relief effort, the affected areas, and which resources or resource types to allocate to the relief effort, for example, using the user interface illustrated in FIG. 32. A similar interface can be provided across a mobile device, for example, using the interfaced illustrated in FIG. 33.

As illustrated at block 3106, additional administrators can be designated. For example, a listing of relief efforts can be provided, and administrators can be invited to participate with the relief effort. For example, a user can utilize the interface illustrated in FIG. 34 to invite administrators for different relief efforts.

Within a given relief effort, coordinators can be invited. For example, upon selecting a relief effort, a list of available coordinators can be provided and invited to participate. Those coordinators that participate can be provided in a list of coordinators associated with a given relief effort, for example, as illustrated in FIG. 35.

Medical or pharmaceutical service providers and facilities can be associated with the relief effort. For example, in the case of testing or vaccination, a particular testing or vaccination facility can be added as a resource into the relief effort record. As illustrated at block 3110, a testing center record can be created, for example, using the interface illustrated in FIG. 36. Such a testing center record may identify the testing facility, the number or types of kits available, current wait time or the availability of the testing facility, a ZIP Code and status.

As illustrated at block 3112, information about testing facilities can be communicated to individuals requesting testing. For example, available testing facilities along with supplies or wait time can be shown to requesting participants. Participants can optionally schedule time with a center or proceed to the facility with available tests or vaccines. In particular, patients can provide details about the visit, such as exposure status or symptoms.

The system can provide the testing facility with information, as illustrated at block 3114, such as a record of incoming patients that may include an identifier and associated symptoms or exposure status. As such, testing facilities can plan for the arrival of patients. For example, as illustrated in FIG. 37, a testing facility can look to see a number of cases that may be arriving at the testing facility, whether immediately or whether scheduled for a future date and time. Optionally, the facility can update the status of the request within the disaster relief system.

In each situation, the disaster relief system can record the transactions in a distributed ledger database, as illustrated at block 3116.

In a first aspect, a method for facilitating disaster relief includes receiving a donation offer at a disaster relief server system. The disaster relief server system stores a plurality of aid requests from a plurality of requesters. Each requester of the plurality of requesters has an associated requester type. The donation offer identifies a good or service. The method further includes receiving a requester restriction associated with the donation offer at the disaster relief server system, the requester restriction providing a constraint on requester type; matching, using the disaster relief server system, an aid request of the plurality of aid requests to the donation offer based at least in part on the good or service and based at least in part on the requester restriction; facilitating, using the disaster relief server system, a transaction provisioning the good or service to the matched aid request; and recording the transaction in a distributed ledger system.

In an example of the first aspect, the distributed ledger system implements Blockchain.

In another example of the first aspect and the above examples, the distributed ledger system is implemented on a private peer-to-peer network.

In a further example of the first aspect and the above examples, the distributed ledger system is implemented on a public peer-to-peer network.

In an additional example of the first aspect and the above examples, the requester type includes 501c3 status.

In another example of the first aspect and the above examples, the requester type includes religious affiliation.

In a further example of the first aspect and the above examples, the requester type includes government affiliation.

In an additional example of the first aspect and the above examples, the method further includes receiving at the disaster relief server system a donor restriction from a requester of the plurality of requesters, the donor restriction providing a constraint on donor type. In an example, matching is further based at least in part on the donor restriction of donor type.

In another example of the first aspect and the above examples, the method further includes receiving at the disaster relief server system an anonymity preference from a donor providing the donor offer.

In a further example of the first aspect and the above examples, the method further includes receiving at the disaster relief server system an anonymity preference from a requester of the plurality of requesters.

In a second aspect, a method for facilitating disaster relief includes receiving an aid request from a requester at a disaster relief server system. The disaster relief server system stores a plurality of donation offers from a plurality of donors. Each donor of the plurality of donors has an associated donor type. The aid request identifies a good or service. The method further includes receiving a donor restriction associated with the donation offer at the disaster relief server system, the requester restriction providing a constraint on donor type; matching, using the disaster relief server system, a donation offer of the plurality of donation offers to the aid request based at least in part on the good or service and based at least in part on the donor restriction; facilitating, using the disaster relief server system, a transaction provisioning the good or service to the matched requester; and recording the transaction in a distributed ledger system.

In an example of the second aspect, the distributed ledger system implements Blockchain.

In another example of the second aspect and the above examples, the distributed ledger system is implemented on a private peer-to-peer network.

In a further example of the second aspect and the above examples, the distributed ledger system is implemented on a public peer-to-peer network.

In an additional example of the second aspect and the above examples, the donor type includes 501c3 status.

In another example of the second aspect and the above examples, the donor type includes religious affiliation.

In a further example of the second aspect and the above examples, the donor type includes government affiliation.

In an additional example of the second aspect and the above examples, the method further includes receiving a requester restriction from a donor of the plurality of donors, the requester restriction providing a constraint on requester type. For example, matching is further based at least in part on the constraint of requester type.

In another example of the second aspect and the above examples, the method further includes receiving an anonymity preference from a donor of the plurality of donors.

In a further example of the second aspect and the above examples, the method further includes receiving an anonymity preference from the requester associated with the aid request.

In a third aspect, a system for facilitating disaster relief includes an identity and access module to manage access to the system; a request workflow module to receive donation offers and requests and match donation offers to requests; an application interface to interact with client applications, the client applications providing information about donation offers and information about requests; and a distributed ledger system to record transactions resulting from matched donation offers and requests.

In an example of the third aspect, the distributed ledger system includes a private peer-to-peer network.

In another example of the third aspect and the above examples, the distributed ledger system includes a public peer-to-peer network.

In a further example of the third aspect and the above examples, the distributed ledger system implements Blockchain.

In an additional example of the third aspect and the above examples, the system further includes an application interface to the distributed ledge system.

In another example of the third aspect and the above examples, they system further includes an interface to external resources. For example, the external resource includes a weather map. In an example, the external resource includes a designation map overlay.

In a further example of the third aspect and the above examples, the system further includes a messaging module.

In an additional example of the third aspect and the above examples, the client applications include a mobile application.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A method for facilitating disaster relief, the method including:
receiving a donation offer at a disaster relief server system, the disaster relief server system storing a plurality of aid requests from a plurality of requesters, each requester of the plurality of requesters having an associated requester type, the donation offer identifying a good or service;
receiving a requester restriction associated with the donation offer at the disaster relief server system, the requester restriction providing a constraint on requester type;
matching, using the disaster relief server system, an aid request of the plurality of aid requests to the donation offer based at least in part on the good or service and based at least in part on the requester restriction;
facilitating, using the disaster relief server system, a transaction provisioning the good or service to the matched aid request; and
recording the transaction in a distributed ledger system.

2. The method of claim 1, wherein the distributed ledger system implements Blockchain.

3. The method of claim 1, wherein the distributed ledger system is implemented on a private peer-to-peer network.

4. The method of claim 1, wherein the distributed ledger system is implemented on a public peer-to-peer network.

5. The method of claim 1, wherein the requester type includes 501c3 status.

6. The method of claim 1, wherein the requester type includes religious affiliation.

7. The method of claim 1, wherein the requester type includes government affiliation.

8. The method of claim 1, further includes receiving at the disaster relief server system a donor restriction from a requester of the plurality of requesters, the donor restriction providing a constraint on donor type.

9. The method of claim 8, wherein matching is further based at least in part on the donor restriction of donor type.

10. The method of claim 1, further comprising receiving at the disaster relief server system an anonymity preference from a donor providing the donor offer.

11. The method of claim 1, further comprising receiving at the disaster relief server system an anonymity preference from a requester of the plurality of requesters.

12. A method for facilitating disaster relief, the method including:
receiving an aid request from a requester at a disaster relief server system, the disaster relief server system storing a plurality of donation offers from a plurality of donors, each donor of the plurality of donors having an associated donor type, the aid request identifying a good or service;
receiving a donor restriction associated with the donation offer at the disaster relief server system, the requester restriction providing a constraint on donor type;
matching, using the disaster relief server system, a donation offer of the plurality of donation offers to the aid request based at least in part on the good or service and based at least in part on the donor restriction;
facilitating, using the disaster relief server system, a transaction provisioning the good or service to the matched requester; and
recording the transaction in a distributed ledger system.

13. The method of claim 12, wherein the distributed ledger system implements Blockchain.

14. The method of claim 12, wherein the distributed ledger system is implemented on a private peer-to-peer network.

15. The method of claim 12, wherein the distributed ledger system is implemented on a public peer-to-peer network.

16. The method of claim 12, wherein the donor type includes 501c3 status.

17. The method of claim 12, wherein the donor type includes religious affiliation.

18. The method of claim 12, wherein the donor type includes government affiliation.

19. The method of claim 12, further includes receiving a requester restriction from a donor of the plurality of donors, the requester restriction providing a constraint on requester type.

20. The method of claim 19, wherein matching is further based at least in part on the constraint of requester type.

21.-32. (canceled)
